(19) United States
(12) Patent Application Publication
(10) Pub. No.: US 2011/0286026 A1
(43) Pub. Date: Nov. 24, 2011

(54) JOB HISTORY INFORMATION AUDIT SYSTEM, INFORMATION PROCESSING APPARATUS, PRINTING APPARATUS, AND AUDIT METHOD

(75) Inventor: Noriko Matsuzawa, Soka-shi (JP)

(73) Assignee: CANON KABUSHIKI KAISHA, Tokyo (JP)

(21) Appl. No.: 13/076,380

(22) Filed: Mar. 30, 2011

(30) Foreign Application Priority Data
May 20, 2010 (JP) 2010-116698

(51) Int. Cl. G06K 15/02; G06F 3/12

(52) U.S. Cl. 358/1.14; 358/1.15

(57) ABSTRACT

An apparatus comprises a unit configured to acquire identification information for identifying a document management server from a cooperation server; a data reception unit configured to receive data including information concerning a job from a printing apparatus, a unit configured to determine; based on the received data and the identification information, whether document data of the received data is document data; a unit configured to store the received data when the determination unit determines that the document data is document data managed by a first document management server; a unit configured to transmit the received data to the cooperation server when the determination unit determines that the document data is carry-in document data which is not managed by the first document management server; a unit configured to receive the instruction associated with permission/inhibition of printing; and a unit configured to transmit the instruction associated with permission/inhibition of printing.

### BACKGROUND OF THE INVENTION

1. Field of the Invention

The present invention relates to a job history information audit system which can record job history information, for example, execution users and execution dates and times concerning, for example, scan, copy, and print jobs executed by an image processing apparatus.

2. Description of the Related Art

Along with the recent popularization of printers and digital multi-function peripherals, anyone can easily execute print, copy, or transmit documents. Although user-friendliness improves in this manner, information leaks caused by printing, copying, and transmission of classified documents raises a new problem. As a measure against this, a digital multi-function peripheral is available which stores job history information in a storage device upon execution of a job such as a print, copy, FAX, or electronic mail transmission job.

A job history information audit system includes the above digital multi-function peripheral and a server. A database is built on the server. Job history information recorded in the digital multi-function peripheral is transmitted to the server and stored in the database. Storing job history information in the database for a predetermined period in a retrievable state allows to track down the job history information when, for example, information leak has been found out.

A technique called cloud computing is available as another background art, which aims at reducing the cost required for the user to build a server and the maintenance load for backup operation. In cloud computing, the user uses services provided on the Internet by service providers. For this reason, the user is only required to prepare a minimum environment including a client for connection to services on the Internet. This can reduce the load on the user.

Above-mentioned digital multi-function peripherals and job history information audit systems are generally operated in intranets because these systems aim at deterring information leak and place importance on security. That is, holding job history information on the Internet will increase the possibility of information leak from the job history information audit system due to virus and hacking attacks and the like. As a countermeasure against such risks, job history information is stored and operated in a network environment (intranet) which takes measures to prevent attacks from external networks by using a firewall and the like.

Japanese Patent Laid-Open No. 2004-208048 has proposed a technique to inhibit a multi-function peripheral from printing unless job history information can be stored. More specifically, in a closed network environment such as a LAN, when the user issues an instruction to print using a multi-function peripheral, this technique checks whether the peripheral can communicate with an apparatus having a storage area such as a print server capable of network connection. The technique inhibits the multi-function peripheral from printing unless it can determine that it is possible to store image data to be output and environment information associated with an printout. This performs control to inhibit printing unless job history information can be held.

As described above, conventional job history information audit systems are generally operated in intranets. When a given user prints document data taken out from an intranet in another company, a convenience store, or the like, he/she cannot leave job history information in the job history information audit system of the local organization. Each company copes with such a case by operation such as inhibiting document data from being taken out from the company or performing access right control on document data. Such operation often depends on the morals of employees, and hence does not exert sufficient security ensuring and information leak deterring effects.

### SUMMARY OF THE INVENTION

The present invention allows a user to record, in a predetermined job history information audit system, job history information concerning document data taken out from the intranet of the local organization. In addition, the present invention inhibits printing of take-out document data unless job history information can be recorded.

According to one aspect of the present invention, there is provided a job history information audit system formed by connecting, to a cooperation server located in an external network, a first document management server and a printing apparatus which are located in an internal network, and a second document management server belonging to a network different from the internal network to which the first document management server belongs, wherein the printing apparatus comprises an acquisition unit configured to recognize a connected portable medium and acquires first data stored in the portable medium, a generation unit configured to generate second data including job history information concerning a history of a job processed by the printing apparatus and the first data, a transmission unit configured to transmit the second data to the first document management server, a reception unit configured to receive an instruction associated with permission/inhibition of printing of the second data from the first document management server, and a printing unit configured to execute print processing when an instruction received by the reception unit permits printing of the second data, the first document management server comprises an acquisition unit configured to acquire identification information for identifying a document management server from the cooperation server, a second data reception unit configured to receive the second data from the printing apparatus, a determination unit configured to determine, based on the second data and the identification information, whether document data of the second data is document data managed by the first document management server, a storage unit configured to store the second data when the determination unit determines that the document data is document data managed by the first document management server, a transmission unit configured to transmit the second data to the cooperation server when the determination unit determines that the document data is carry-in document data which is not managed by the first document management server, an instruction reception unit configured to receive the instruction associated with permission/inhibition of printing based on a result of storing processing for the second data transmitted from the cooperation server by the transmission unit, and an instruction transmission unit configured to transmit the instruction associated with permission/inhibition of printing to the printing apparatus, the second document management server comprises an acquisition unit configured to acquire second data corresponding to document data managed by the second document management server from the cooperation server, a second data storage unit configured to perform storing processing of second data corresponding to document data acquired by the acquisition unit and managed by the second document management server, and a transmission unit configured to transmit a result of processing by the second data storage unit to the cooperation server, and the cooperation server comprises an assignment unit configured to assign a storage area for the identification information and data corresponding to the identification information to each document management server, a reception unit configured to receive the second data from the first document management server, a storage unit configured to store the received second data in the storage area of the data corresponding to the identification information based on the identification information of the second data received by the reception unit, a second data transmission unit configured to transmit, to the second document management server, second data corresponding to document data managed by the second document management server, a result reception unit configured to receive a result of storing processing for the second data from the second document management server, and a transmission unit configured to transmit, to the first document management server, the instruction associated with permission/inhibition of printing based on the result of the storing processing received from the second document management server.

According to another aspect of the present invention, there is provided an information processing apparatus functioning as a first document management server of a job history information audit system formed by connecting, to a cooperation server located in an external network, the first document management server and a printing apparatus which are located in an internal network, and a second document management server belonging to a network different from the internal network to which the first document management server belongs, comprising: an acquisition unit configured to acquire identification information for identifying a document management server from the cooperation server; a data reception unit configured to receive data including information concerning a job processed by the printing apparatus from the printing apparatus, a determination unit configured to determine; based on the received data and the identification information, whether document data of the received data is document data managed by the first document management server; a storage unit configured to store the received data when the determination unit determines that the document data is document data managed by the first document management server; a transmission unit configured to transmit the received data to the cooperation server when the determination unit determines that the document data is carry-in document data which is not managed by the first document management server; an instruction reception unit configured to receive the instruction associated with permission/inhibition of printing based on a result of storing processing for the data transmitted from the cooperation server by the transmission unit; and an instruction transmission unit configured to transmit the instruction associated with permission/inhibition of printing to the printing apparatus.

According to another aspect of the present invention, there is provided an information processing apparatus functioning as a second document management server of a job history information audit system formed by connecting, to a cooperation server located in an external network, a first document management server and a printing apparatus which are located in an internal network, and the second document management server belonging to a network different from the internal network to which the first document management server belongs, comprising: an acquisition unit configured to acquire data corresponding to document data managed by the second document management server from the cooperation server; a data storage unit configured to perform storing processing of data corresponding to document data acquired by the acquisition unit and managed by the second document management server; and a transmission unit configured to transmit a result of processing by the data storage unit to the cooperation server.

According to another aspect of the present invention, there is provided an information processing apparatus functioning as a cooperation server of a job history information audit system formed by connecting, to the cooperation server located in an external network, a first document management server and a printing apparatus which are located in an internal network, and a second document management server belonging to a network different from the internal network to which the first document management server belongs, comprising: an assignment unit configured to assign a storage area for the identification information and data corresponding to the identification information to each document management server; a reception unit configured to receive data including information concerning a job processed by the printing apparatus from the first document management server; a storage unit configured to store the received data in the storage area of the data corresponding to the identification information based on the identification information of the data received by the reception unit; a data transmission unit configured to transmit, to the second document management server, data corresponding to document data managed by the second document management server; a result reception unit configured to receive a result of storing processing for the data transmitted by the data transmission unit from the second document management server; and a transmission unit configured to transmit, to the first document management server, the instruction associated with permission/inhibition of printing based on the result of the storing processing received from the second document management server.

According to another aspect of the present invention, there is provided a printing apparatus of a job history information audit system formed by connecting, to a cooperation server located in an external network, a first document management server and the printing apparatus which are located in an internal network, and a second document management server belonging to a network different from the internal network to which the first document management server belongs, comprising: an acquisition unit configured to recognize a connected portable medium and acquires first data stored in the portable medium; a generation unit configured to generate second data including job history information concerning a history of a job processed by the printing apparatus and the first data; a transmission unit configured to transmit the second data to the first document management server; a reception unit configured to receive an instruction associated with permission/inhibition of printing of the second data from the first document management server; and a printing unit configured to execute print processing when an instruction received by the reception unit permits printing of the second data.

According to another aspect of the present invention, there is provided a job history information audit system formed by connecting, to a cooperation server located in an external network, a printing apparatus located in an internal network and a document management server belonging to a network different from the internal network to which the printing apparatus belongs, wherein the printing apparatus comprises an acquisition unit configured to recognize a connected portable medium and acquire first data stored in the portable medium, a generation unit configured to generate second data including job history information concerning a history of a job processed by the printing apparatus and the first data, a transmission unit configured to transmit the second data to the cooperation server, a reception unit configured to receive an instruction associated with permission/inhibition of printing of the second data from the cooperation server, and a printing unit configured to execute print processing when an instruction received by the reception unit permits printing of the second data, the document management server comprises an acquisition unit configured to acquire second data corresponding to document data managed by the document management server from the cooperation server, a storage unit configured to perform storing processing of the second data corresponding to the document data managed by the document management server which is acquired by the acquisition unit, and a transmission unit configured to transmit a processing result obtained by the storage unit to the cooperation server, and the cooperation server comprises an assignment unit configured to assign a storage area for the identification information and data corresponding to the identification information to each document management server, a reception unit configured to receive the second data from the printing apparatus, a storage unit configured to store the received second data in the storage area of the data corresponding to the identification information based on the identification information of the second data received by the reception unit, a second data transmission unit configured to transmit, to the document management server, second data corresponding to document data managed by the document management server, a result reception unit configured to receive a result of storing processing for the second data from the document management server, and a transmission unit configured to transmit, to the printing apparatus, the instruction associated with permission/inhibition of printing based on the result of the storing processing received from the document management server.

According to another aspect of the present invention, there is provided a job history information audit system formed by connecting a document management server and a printing apparatus which are located in an internal network to a cooperation server located in an external network, wherein the printing apparatus comprises an acquisition unit configured to recognize a connected portable medium and acquire first data stored in the portable medium, a generation unit configured to generate second data including job history information concerning a history of a job processed by the printing apparatus and the first data, a transmission unit configured to transmit the second data to the first document management server, a reception unit configured to receive an instruction associated with permission/inhibition of printing of the second data from the first document management server, and a printing unit configured to execute print processing when an instruction received by the reception unit permits printing of the second data, the document management server comprises an acquisition unit configured to acquire identification information for identifying a document management server from the cooperation server, a second data reception unit configured to receive the second data from the printing apparatus, a determination unit configured to determine, based on the second data and the identification information, whether document data of the second data is document data managed by the first document management server, a storage unit configured to store the second data when the determination unit determines that the document data is document data managed by the first document management server, a transmission unit configured to transmit the second data to the cooperation server when the determination unit determines that the document data is carry-in document data which is not managed by the first document management server, an instruction reception unit configured to receive the instruction associated with permission/inhibition of printing based on a result of storing processing for the second data transmitted from the cooperation server by the transmission unit, and an instruction transmission unit configured to transmit the instruction associated with permission/inhibition of printing to the printing apparatus, and the cooperation server comprises an assignment unit configured to assign a storage area for the identification information and data corresponding to the identification information to each document management server, a reception unit configured to receive the second data from the document management server, a storage unit configured to store the received second data in the storage area of the data corresponding to the identification information based on the identification information of the second data received by the reception unit, and a transmission unit configured to transmit, to the printing apparatus, the instruction associated with permission/inhibition of printing based on a result of the storing processing in the storage unit.

According to another aspect of the present invention, there is provided an audit method in a job history information audit system formed by connecting, to a cooperation server located in an external network, a first document management server and a printing apparatus which are located in an internal network, and a second document management server belonging to a network different from the internal network to which the first document management server belongs, comprising: in the printing apparatus, an acquisition step of causing an acquisition unit to recognize a connected portable medium and acquire first data stored in the portable medium, a generation step of causing a generation unit to generate second data including job history information concerning a history of a job processed by the printing apparatus and the first data, a transmission step of causing a transmission unit to transmit the second data to the first document management server, a reception step of causing a reception unit to receive an instruction associated with permission/inhibition of printing of the second data from the first document management server, and a printing step of causing a printing unit to execute print processing when an instruction received in the reception step permits printing of the second data, in the first document management server, an acquisition step of causing an acquisition unit to acquire identification information for identifying a document management server from the cooperation server, a second data reception step of causing a second data reception unit to receive the second data from the printing apparatus, a determination step of causing a determination unit to determine, based on the second data and the identification information, whether document data of the second data is document data managed by the first document management server, a storage step of causing a storage unit to store the second data when it is determined in the determination step in the first document management server that the document data is document data managed by the first document management server, a transmission step of causing a transmission unit to transmit the second data to the cooperation server when it is determined in the determination step in the first document management server that the document data is carry-in document data which is not managed by the first document management server, an instruction reception step of causing an instruction reception unit to receive the instruction associated with permission/inhibition of printing based on a result of storing processing for the second data transmitted from the cooperation server in the transmission step in the first document management server, and an instruction transmission step of causing an instruction transmission unit to transmit the instruction associated with permission/inhibition of printing to the printing apparatus, in the second document management server, an acquisition step of causing an acquisition unit to acquire second data corresponding to document data managed by the second document management server from the cooperation server; a second data storage step of causing a second data storage unit to perform storing processing of second data corresponding to document data acquired in the acquisition step in the second document management server and managed by the second document management server, and a transmission step of causing a transmission unit to transmit a result of processing in the step of causing the second data storage unit of the second document management server to store to the cooperation server, and in the cooperation server, an assignment step of causing an assignment unit to assign a storage area for the identification information and data corresponding to the identification information to each document management server, a reception step of causing a reception unit to receive the second data from the first document management server, a storage step of causing a storage unit to store the received second data in the storage area of the data corresponding to the identification information based on the identification information of the second data received in the reception step in the cooperation server, a second data transmission step of causing a second data transmission unit to transmit, to the second document management server, second data corresponding to document data managed by the second document management server, a result reception step of causing a result reception unit to receive a result of storing processing for the second data from the second document management server, and a transmission step of causing a transmission unit to transmit, to the first document management server, the instruction associated with permission/inhibition of printing based on the result of the storing processing received from the second document management server.

A user can record, in a predetermined job history information audit system, a job history concerning document data taken out from the intranet of the local organization. If the user cannot record a job history to be managed, printing of document data is inhibited. This makes it possible to deter information leak in a system regardless of user operation.

Further features of the present invention will become apparent from the following description of exemplary embodiments (with reference to the attached drawings).

### BRIEF DESCRIPTION OF THE DRAWINGS

FIG. 1 is a view showing the overall arrangement of a job history information audit system according to the first embodiment;

FIG. 2 is a block diagram showing the hardware arrangement of each server according to this embodiment;

FIG. 3 is a block diagram showing the arrangement of a digital multi-function peripheral according to this embodiment;

FIG. 4 is a block diagram showing an example of the software arrangement of each server according to this embodiment;

FIG. 5 is a flowchart showing the processing of setting operation conditions according to this embodiment;

FIG. 6 is a flowchart for storing document data in a portable medium according to this embodiment;

FIGS. 7A and 7B are flowcharts for printing document data according to the first embodiment;

FIG. 8 is a flowchart showing the processing of acquiring information according to the first embodiment;

FIG. 9 is a flowchart showing the processing of storing job history information according to the first embodiment;

FIG. 10 is a flowchart showing the processing of performing user authentication according to the first embodiment;

FIG. 11 is a view showing the overall arrangement of a job history information audit system according to the second embodiment; and

FIG. 12 is a flowchart for printing document data according to the second embodiment.

### DESCRIPTION OF THE EMBODIMENTS

### First Embodiment

An embodiment for carrying out the present invention will be described below with reference to the accompanying drawings. Note that in this embodiment, pieces of information concerning job histories will be collectively expressed as “job history information”. An example of job history information includes job attribute information such as information indicating the user who has executed a job, information indicating the date and time when the job was executed, information (an IP address and serial number) specifying the digital multi-function peripheral which has executed the job, and the type of executed job. This job history information may also include image data obtained by converting an input image into data or reduced image data obtained by reducing the image data. Image data obtained by converting an input image into data, document data, and reduced image data obtained by reducing them will be referred to as “image data”. A text extracted by performing OCR processing for image data will be referred to as “text information”. Information such as information indicating the user who executes a job, information indicating the date and time when the job was executed, information (an IP address and serial number) specifying the digital multi-function peripheral which executes the job, and the type of job to be executed will be referred to as “job attribute”.

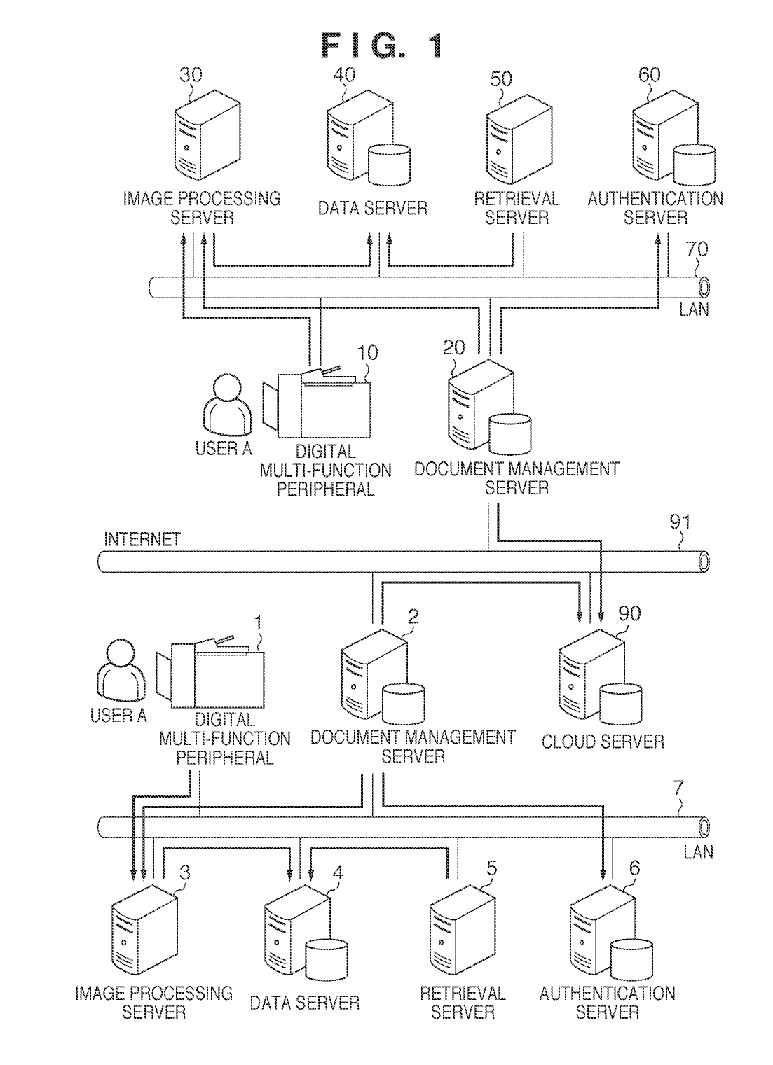

In this embodiment, the term “cloud server” is used. However, the definition of “cloud computing” in “BACKGROUND OF THE INVENTION” is a general definition, and differs from the concept of a “cloud server” used in this embodiment. A “cloud server” functions as a relay server or cooperation server to connect job history information audit systems built in the LAN environments of the respective organizations to each other by using servers on the Internet. A detailed definition of the term “cloud server” used in this embodiment will be described with reference to FIG. 1.

[System Arrangement]

FIG. 1 is a view showing the overall arrangement of a job history information audit system according to an embodiment of the present invention. In this case, a digital multi-function peripheral 1 as an example of an image processing apparatus on a network, a document management server 2, an image processing server 3, a data server 4, a retrieval server 5, and an authentication server 6 are connected to each other via a LAN 7. Likewise, a digital multi-function peripheral 10, a document management server 20, an image processing server 30, a data server 40, a retrieval server 50, and an authentication server 60 are connected to each other via a LAN 70. The document management servers 2 and 20 and a cloud server 90 are connected to each other via Internet 91. FIG. 1 shows two internal networks to discriminate a document management system and a job history information audit system from each other, which are operated by the respective organizations in different intranet environments. Since the basic operation of the internal network connected to the LAN 7 is the same as that of the internal network connected to the LAN 70, and hence the apparatuses located in the internal network connected to the LAN 7 will be exemplified here. The digital multi-function peripheral 1 has functions such as scan, print, copy, electronic mail, and FAX functions. The digital multi-function peripheral 1 also has a function of allowing a portable medium such as a USB to be connected, reading data inside the medium, and executing a job such as a print job.

The digital multi-function peripheral 1 has a function of recording job history information concerning a job executed on the equipment simultaneously with printing operation, and transmits the locally stored job history information to the document management server 2 as soon as the time comes to transmit. The document management server 2 has a function associated with document management such as creation, registration, browsing, editing, and deletion of document data. The authentication server 6 acquires an authentication result on a user who is logging in to the document management server 2 or a user who has executed a job, by transmitting user information to the authentication server 6, and controls an access right.

The document management server 2 has a function of encrypting document data in the document management server and then storing the data in a portable medium such as a USB medium. The document management server 2 has a function of connecting to the cloud server 90 and acquiring information stored in the cloud server 90. The document management server 2 also has a function of connecting to the image processing server 3 and transmitting document data and job history information. The document management server 2 further has a function of receiving a job history information storing result from the image processing server 3 and transmitting a decryption key for decrypting document data to the cloud server 90 if the result indicates a success.

The image processing server 3 performs data conversion processing for the job history information transmitted from the document management server 2, and stores the resultant information in the data server 4. The data conversion processing is the processing of extracting text information by performing OCR processing for image data or converting the format of image data. The data server 40 stores the text information obtained by the data conversion processing upon associating the information with job history information. This information is used for the retrieval of job history information.

The data server 4 stores the image data transmitted from the image processing server 3 and the image data, text information, and job attributes associated with job history information. Although this embodiment is based on the assumption that each data server includes a database, it does not matter whether each data server includes a database or a file system, as long as it is a storage unit capable of storing job history information.

After the user designates retrieval conditions, the retrieval server 5 acquires job history information stored in the data server 4 which matches the retrieval conditions, and presents the job history information to the user. Retrieval conditions include job attributes such as the user who has executed a job and the date and time when the user executed the job, a character string included in text information, and image data. The retrieval server 5 retrieves job history information stored in the data server 4 by using the designated retrieval conditions as keywords. The authentication server 6 transmits, to the document management server, a result of checking whether the corresponding user exists and, if the user exists, authorization information about the user, based on the user information received from the document management server 2. The authorization information includes at least an access right such as a read right, a write right, or a delete right.

The cloud server 90 is a server existing on the Internet. This server issues a global ID which is identification information uniquely identifiable for each document management server operated in each organization, and manages a storage area for storing information for each global ID. The cloud server 90 also stores information in the storage area of the corresponding global ID based on the information received from the document management server 2 (including a global ID, job attributes, a document path, and job history information). In addition, the cloud server 90 has a function of receiving a decryption key from the document management server 2 and transmitting it to the digital multi-function peripheral 1. The cloud server 90 according to this embodiment is not based on the assumption that sufficient services are provided as in the case of general cloud computing, and functions more as a relay server.

FIG. 1 shows the respective PCs as different constituent elements. However, one PC may include the functions of them. In addition, these functions may be included in any combinations and in any numbers of PCs.

In this embodiment, for the sake of convenience, a document management server on the side where carry-in document data is printed will be referred to as the first document management server, and a document management server on the side where document data is taken out will be referred to as the second document management server.

[Hardware Arrangement]

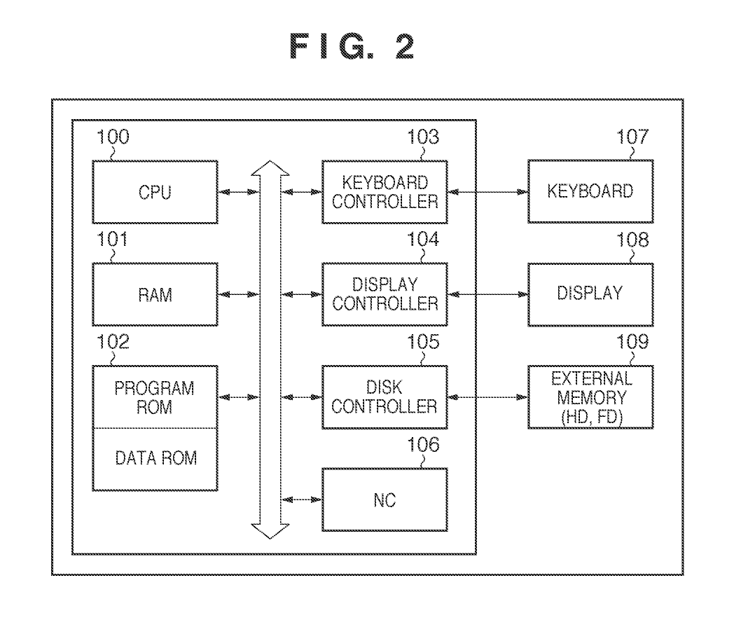

FIG. 2 is a block diagram showing the hardware arrangement of each information processing apparatus forming each of the servers shown in FIG. 1, including the document management server 2, the image processing server 3, the data server 4, the retrieval server 5, the authentication server 6, and the cloud server 90. The hardware arrangement diagram shown in FIG. 2 corresponds to the hardware arrangement diagram of a general information processing apparatus, and the hardware arrangement of the general information processing apparatus can be applied to each server in this embodiment.

Referring to FIG. 2, a CPU 100 executes programs such as an OS and applications stored in the program ROM of a ROM 102 or loaded from an external memory (HDD) 109 into a RAM 101. In this case, OS is an abbreviation for operating system operating on a computer, and the operating system will be referred to as the OS hereinafter. The CPU 100 can implement the processing in each flowchart (to be described later) by executing programs. The RAM 101 functions as the main memory, work area, or the like of the CPU 100. A keyboard controller 103 controls key input from a keyboard 107 and a pointing device (not shown). A display controller 104 controls display of various types of displays 108. A disk controller 105 controls data accesses to the hard disk (HD) 109, a floppy® disk (FD), and a portable medium such as a USB, which store various data. An NC 106 is connected to the network, and executes communication control processing with other devices connected to the network.

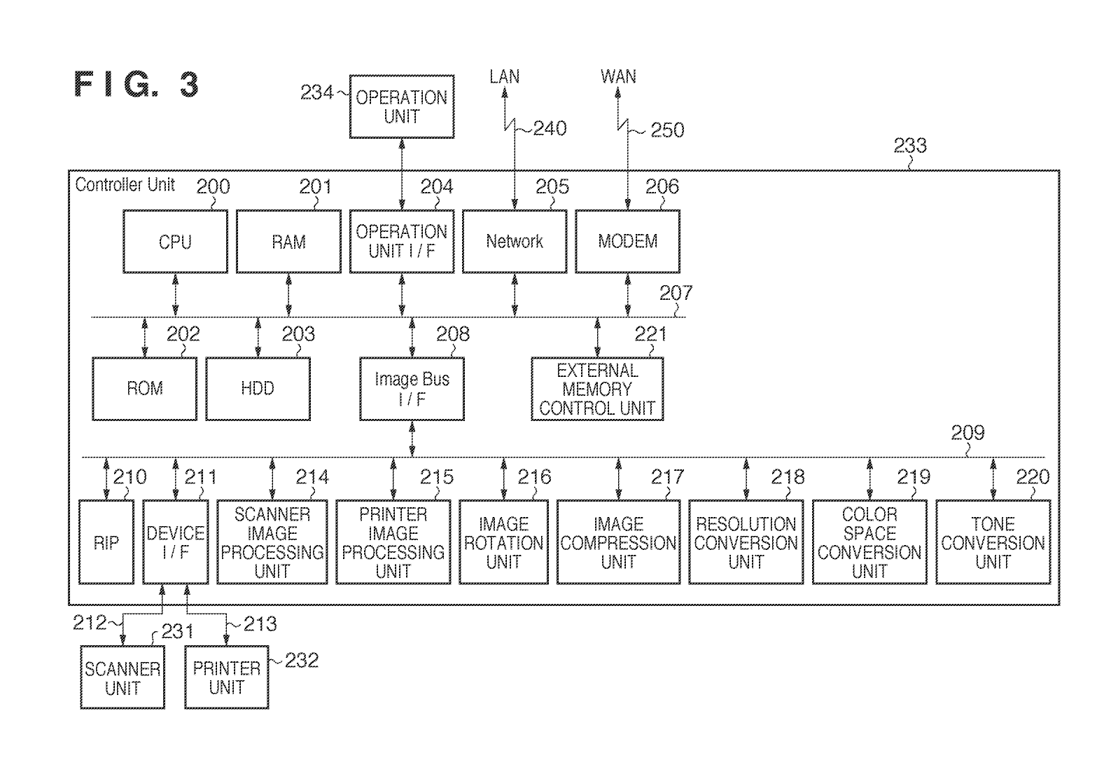

FIG. 3 is a block diagram showing the arrangement of the digital multi-function peripheral 1 shown in FIG. 1. A controller unit 233 is connected to a scanner unit 231 as an image input device and a printer unit 232 as an image output device. Also, the controller unit 233 is connected to a network (LAN) 240 and public network (WAN) 250. With this arrangement, the controller unit 233 inputs and outputs image data and device information. In the controller unit 233, a CPU 200 is a controller which controls the overall system. A RAM 201 is a system work memory required for the CPU 200 to operate, and also an image memory (buffer memory) used to temporarily store input image data. A ROM 202 is a boot ROM, and stores a boot program of the system.

A hard disk drive (HDD) 203 stores system software, job history information, image data in the user BOX, and the like. The system software stored in the HDD 203 implements a function of storing, in the digital multi-function peripheral, job history information about a job executed in the digital multi-function peripheral, and transmitting it to the server. An operation unit I/F 204 is an interface unit with an operation unit 234, and outputs screen data to be displayed on the operation unit 234 to the operation unit 234. The operation unit I/F 204 has a role to transfer information input by the operator from the operation unit 234 to the CPU 200. Note that the operation unit 234 may be either a screen provided on the digital multi-function peripheral or a screen (display 108) remotely provided by a program in the digital multi-function peripheral from an external device such as a PC.

A network unit (Network) 205 is connected to the network (LAN) 240 to input and output information. A modem (MODEM) 206 is connected to the public line (WAN) 250 to input and output image data. The above devices are arranged on a system bus 207. An image bus (Image Bus) I/F 208 is a bus bridge which connects the system bus 207 and an image bus 209 which transmits image data at high speed. The bus bridge then converts data structures.

The following devices are arranged on the image bus 209. A raster image processor (RIP) 210 rasterizes PDL code data into bitmap image data. A device I/F 211 connects the scanner unit 231 and printer unit 232 as image input/output devices to the controller unit 233 via an image input unit interface 212 and print unit interface 213 to convert image data. A scanner image processing unit 214 corrects, processes, and edits input image data. The scanner image processing unit 214 has a function of judging, based on a saturation signal of image data, whether the input image data is that of a color or monochrome document, and holding the determination result. A printer image processing unit 215 corrects, processes, and edits output image data.

An image rotation unit 216 rotates image data simultaneously with image reading from the scanner unit 231 in cooperation with the scanner image processing unit 214, and stores the rotated image data in a memory. The image rotation unit 216 can also rotate image data in the memory, and store it in the memory, or can print out image data in the memory while rotating it in cooperation with the printer image processing unit 215. An image compression unit 217 performs JPEG compression/decompression processing for multilevel image data and JBIG, MMR, MR, or MH compression/decompression processing for binary image data. A resolution conversion unit 218 performs resolution conversion processing for image data in the memory, and stores the processed data in the memory. A color space conversion unit 219 converts, for example, YUV image data in the memory into Lab image data using matrix computation, and stores the converted data in the memory. A tone conversion unit 220 converts, for example, 8-bit, 256-tone image data in the memory into 1-bit, 2-tone image by a method such as error diffusion processing, and stores the converted data in the memory. The image rotation unit 216, image compression unit 217, resolution conversion unit 218, color space conversion unit 219, and tone conversion unit 220 can operate in cooperation with each other. For example, when image data in the memory is to undergo image rotation and resolution conversion, these two processes can be performed without via the memory. An external memory control unit 221 is connected to an external memory such as a portable medium to control data input/output operation.

[Software Arrangement]

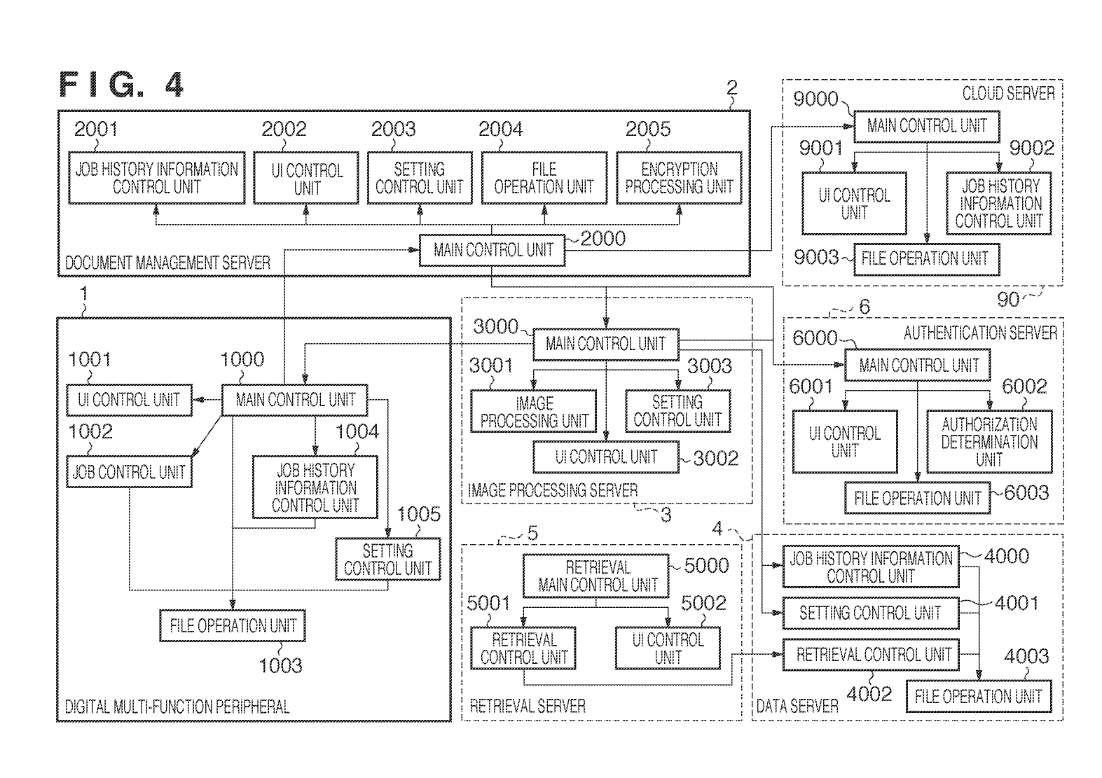

FIG. 4 is a block diagram showing an example of the software arrangement of the digital multi-function peripheral 1, document management server 2, image processing server 3, data server 4, retrieval server 5, authentication server 6, and cloud server 90 shown in FIG. 1. In the digital multi-function peripheral 1, a main control unit 1000 controls the overall digital multi-function peripheral 1, and instructs and manages the respective units in the apparatus. In addition, the main control unit 1000 issues a job execution instruction to a job control unit 1002 and a job history information generation instruction to a job history information control unit 1004 in accordance with the contents of user instructions from a UI control unit 1001. Furthermore, transmission processing for job history information is performed via the main control unit 1000.

The UI control unit 1001 totally controls processing associated with user operation in the digital multi-function peripheral 1. More specifically, the UI control unit 1001 displays a user interface on the operation unit 234 of the digital multi-function peripheral 1, and passes the contents of instructions received from the user to the main control unit 1000. The user also performs print operation, via the UI control unit 1001, from an external memory recognized by the external memory control unit 221. The job control unit 1002 receives a user instruction via the main control unit 1000, and executes a designated job. In this case, the job control unit 1002 refers to setting information, image data, and job attribute information in the HDD 203 via the main control unit 1000 and a file operation unit 1003.

The file operation unit 1003 is a control unit required to input and output setting information, image data, and job attribute information in the HDD 203, and executes processing in response to processing requests from the respective units. The job history information control unit 1004 generates job history information (including, for example, image data and job attribute information) at the time of execution of a job in accordance with an instruction from the main control unit 1000, and stores the job history information via the file operation unit 1003. In addition, the job history information control unit 1004 stores setting information associated with job history information generation and job history information transmission via the file operation unit 1003. A setting control unit 1005 controls operation condition setting information associated with the digital multi-function peripheral 1. The setting control unit 1005 receives an operation condition setting instruction via the main control unit 1000, and refers to and stores the setting information via the file operation unit 1003.

In the document management server 2, a main control unit 2000 controls the overall document management server 2 to instruct and manage the respective units. Mainly, the main control unit 2000 receives user information and job history information from the main control unit 1000 of the digital multi-function peripheral 1, and stores the job history information in the data server 4 via a main control unit 3000 of the image processing server 3. The main control unit 2000 also acquires job history information via a main control unit 9000 of the cloud server 90, and stores the job history information in the data server 4 via the main control unit 3000 of the image processing server 3. In addition, the main control unit 2000 transmits user information to a main control unit 6000 of the authentication server 6, and receives a user authentication result.

A job history information control unit 2001 acquires job history information stored in the cloud server 90 via the main control unit 2000 and the main control unit 9000 of the cloud server 90. A UI control unit 2002 displays a user interface on the display 108 of the document management server 2, and receives an instruction issued by the user using the keyboard 107. The UI control unit 2002 also stores the setting information designated by the user via the main control unit 2000 and a setting control unit 2003. The user issues an instruction to store document data in an external memory via the UI control unit 2002. The setting control unit 2003 controls operation condition setting information concerning the document management server 2. The setting control unit 2003 receives operation condition setting information via the main control unit 2000 and stores the setting information via a file operation unit 2004.

The file operation unit 2004 is a control unit for managing setting information and document data in the HDD 109, and executes processing in response to processing requests from the respective units. This control unit also performs storing processing for document data in a portable medium or a folder. An encryption processing unit 2005 holds encryption and decryption keys. The encryption processing unit 2005 encrypts document data in accordance with an instruction from the main control unit 2000. The encryption processing unit 2005 also transmits a decryption key to the cloud server 90 in accordance with an instruction from the main control unit 2000.

In the image processing server 3, the main control unit 3000 controls the overall image processing server 3, and instructs and manages the respective units in the apparatus. The main control unit 3000 receives document data and job history information from the document management server 2. An image processing unit 3001 performs OCR processing and image format conversion for image data in accordance with instructions from the main control unit 3000. A UI control unit 3002 displays a user interface on the display 108 of the image processing server 3, and receives an instruction issued by the user using the keyboard 107. The UI control unit 3002 stores setting information designated by the user in the data server 4 via the main control unit 3000. A setting control unit 3003 controls operation condition setting information concerning the image processing server 3. The setting control unit 3003 receives an operation condition setting instruction via the main control unit 3000, and stores the setting information in the data server 4.

In the data server 4, a job history information control unit 4000 receives job history information reference and store instructions via the main control unit 3000 of the image processing server 3, and executes job history information control in accordance with the instructions. A setting control unit 4001 receives reference and store instructions associated with setting information of each constituent element via the main control unit 3000 of the image processing server 3, and executes setting information control in accordance with the instructions. A retrieval control unit 4002 receives retrieval conditions and a retrieval execution instruction from the retrieval server 5, and returns retrieval results. A file operation unit 4003 receives instructions from the respective control units, and refers to and stores setting information and job history information in the HDD 109.

In the retrieval server 5, a retrieval main control unit 5000 controls the overall retrieval server 5, and instructs and manages respective units in the apparatus. A retrieval control unit 5001 controls retrieval processing. The retrieval control unit 5001 issues a retrieval instruction to the retrieval control unit 4002 of the data server 4 based on retrieval conditions received from the retrieval main control unit 5000, and receives retrieval results. The retrieval control unit 5001 also executes sort or the like of the retrieval results as needed, and transfers the retrieval results to the retrieval main control unit 5000. A UI control unit 5002 displays a user interface on the display 108 of the retrieval server 5 so as to set retrieval conditions, and receives retrieval conditions set by the user using the keyboard 107. The UI control unit 5002 transfers the received retrieval conditions to the retrieval control unit 5001 via the retrieval main control unit 5000. The UI control unit 5002 presents, via the user interface, the retrieval results received from the retrieval control unit 5001 via the retrieval main control unit 5000 to the user.

In the authentication server 6, the main control unit 6000 controls the overall authentication server 6, and instructs and manages the respective units in the apparatus. A UI control unit 6001 displays a user interface on the display 108 of the authentication server 6, and receives an instruction issued by the user using the keyboard 107. The UI control unit 6001 stores user authentication setting information designated by the user via a file operation unit 6003. An authorization determination unit 6002 acquires, from the file operation unit 6003, user authorization information designated from the document management server 2 and the image processing server 3, and transmits the acquired information to the document management server 2. The file operation unit 6003 is a control unit for inputting and outputting setting information such as user information in the HDD 109, and executes processing in response to processing requests from the respective units.

In the cloud server 90, the main control unit 9000 controls the overall cloud server 90, and instructs and manages the respective units in the apparatus. The main control unit 9000 issues a global ID for each document management server operated in each organization, and stores the global ID as setting information via a file operation unit 9003. This implements an assignment unit. The main control unit 9000 also stores, via the file operation unit 9003, information received via the main control unit 2000 of the document management server 2. A UI control unit 9001 displays a user interface on the display 108 of the cloud server 90, and receives an instruction issued by the user using the keyboard 107. The UI control unit 9001 stores setting information designated by the user concerning the cloud server 90 and setting information for each organization using the cloud server 90 via the file operation unit 9003. Assume that the user interface in this case is used by an organization providing the cloud server 90. A job history information control unit 9002 specifies an area to store job history information in accordance with setting information for each organization using the cloud server 90, and stores job history information and the like in the corresponding storage area. The file operation unit 9003 is a control unit for inputting and outputting setting information and job history information in the HDD 109, and executes processing in response to processing requests from the respective units.

[Operation Condition Setting Processing]

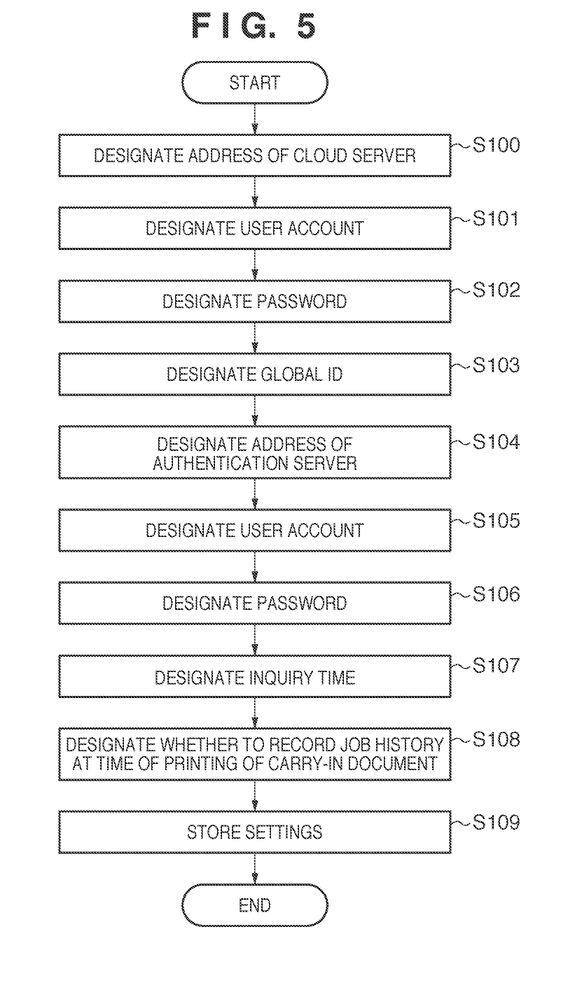

FIG. 5 is a flowchart showing the processing of setting operation conditions associated with the document management server 2 in this embodiment. In operation condition setting, the UI control unit 2002 of the document management server 2 receives user's designation. Assume that the document management server 2 stores the designated settings in the HDD 109 via the file operation unit 2004. However, the document management server 2 may store the setting information in the HDD 109 of the data server 4 instead of the HDD 109 of the document management server 2. This implements a condition reception unit.

In step S100, the user designates address information of the cloud server 90 via the UI control unit 2002. Assume that address information is a URL, a URI, or an IP address. However, this information is not limited to any specific kind of information as long as it can specify the cloud server 90. In step S101, the user designates user account information for connection to the cloud server 90 via the UI control unit 2002. Assume that this user information is information obtained when the user subscribes to an organization which provides a cloud server.

In step S102, the user designates, via the UI control unit 2002, a password corresponding to the user account designated in step S101. In step S103, the user designates, via the UI control unit 2002, a global ID assigned to the local organization which manages the cloud server. Assume that in this embodiment, a global ID is issued and managed by the cloud server 90, and can be acquired only when the user subscribes to the organization which provides the cloud server 90. In step S104, the user designates address information of the authentication server 6 via the UI control unit 2002. Assume that address information is a URL, a URI, or an IP address. However, this information is not limited to any specific kind of information as long as it can specify the authentication server 6.

In step S105, the user designates a user account when transmitting document data from the document management server 2 to the image processing server 3 via the UI control unit 2002. The user makes this setting only when required in accordance with the implementation form of the document management server 2. For example, when the user always uses a system account in a program, it is not necessary to make the setting. In step S106, the user designates a password corresponding to step S105 via the UI control unit 2002. In step S107, the user designates the time when the document management server 2 makes an inquiry to the cloud server 90 via the UI control unit 2002.

In step S108, the user designates, via the UI control unit 2002, whether to record job history information when printing carry-in document data. Assume that the user makes this setting in accordance with the necessity of a job history concerning document data carried in by the user. In step S109, the user issues, via the UI control unit 2002, an instruction to store the setting information designated by the user in step S100 and the subsequent steps. Upon receiving the storing instruction, the UI control unit 2002 stores the setting information in the HDD 109 of the document management server 2 via the main control unit 2000 and the file operation unit 2004.

[Document Data Storing Processing]

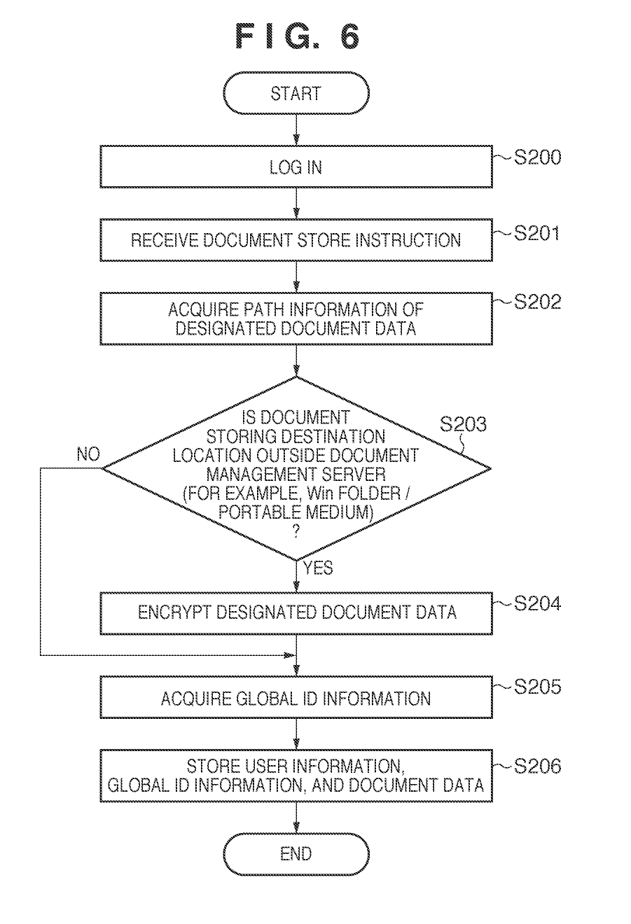

FIG. 6 is a flowchart for storing document data from the document management server 2 according to this embodiment into a portable medium. This operation in the embodiment will be described based on the assumption that document data is stored in a portable medium. However, the location to store document data may be any location, such as a folder in a Windows® OS (to be referred to as a Windows® folder hereinafter) and other systems, from which document data can be taken out, via them, from the intranet of the local organization. In addition, this flowchart may be applied to a case in which document data is stored in a folder in the document management server 2.

In step S200, the user logs in to the document management server 2 via the UI control unit 2002. Assume that in this embodiment, the user performs log-in operation based on a user account and a password. Since this technique is known, a detailed description of it will be omitted. In step S201, the user designates document data to be stored and a document storing destination and issues an instruction to store a document via the UI control unit 2002. In step S202, the main control unit 2000 acquires the path information of the designated document data to be stored from the UI control unit 2002. This path information is path information which can be recognized in the document management server 2, and includes version information as needed.

In step S203, the main control unit 2000 checks whether the document storing destination designated in step S202 is a location outside the document management server, for example, a Window® folder or portable medium. If the document storing destination checked in this step is a location outside the document management server (YES in step S203), the main control unit 2000 encrypts the designated document data in step S204. The main control unit 2000 encrypts the document data by acquiring the document data from the file operation unit 2004 and instructing the encryption processing unit 2005 to encrypt the data. In step S205, the main control unit 2000 acquires, via the setting control unit 2003, the global ID assigned to the local organization which is designated in step S103 in FIG. 5. In step S206, the main control unit 2000 stores, at the document storing destination acquired in step S201, the user information acquired in step S200, the document data encrypted in step S204, and the global ID of the local organization acquired in step S205. This implements a portable medium storage unit. Note that if a document storing destination is located inside the document management server, document data may be document data which is not encrypted in step S202. For the sake of convenience, data handled in step S206 will also be referred to as the first data.

[Procedure for Print Processing]

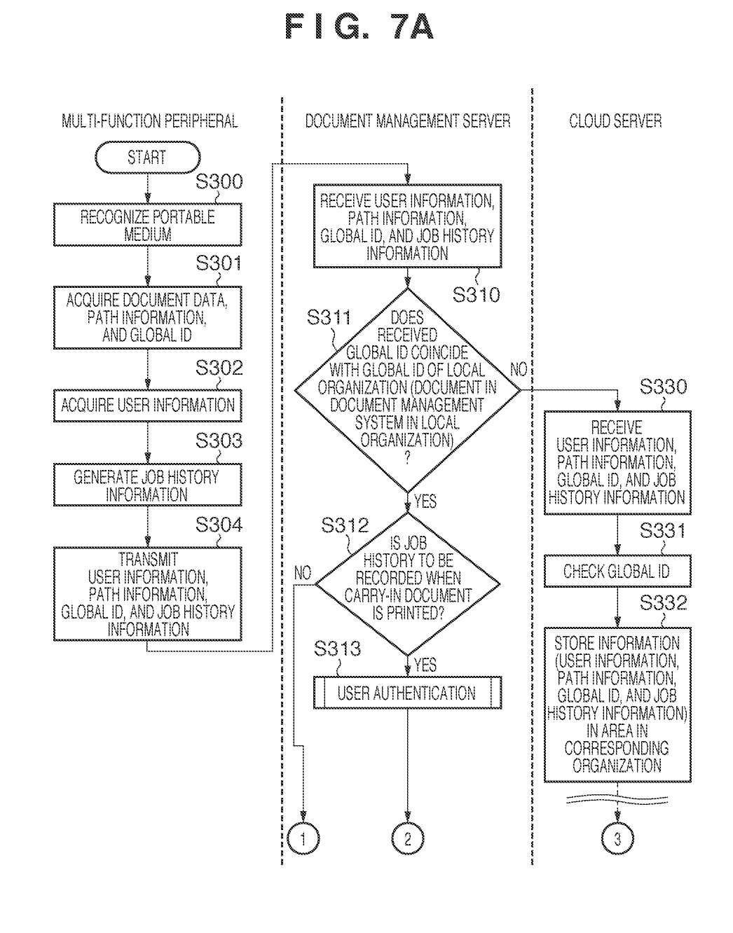

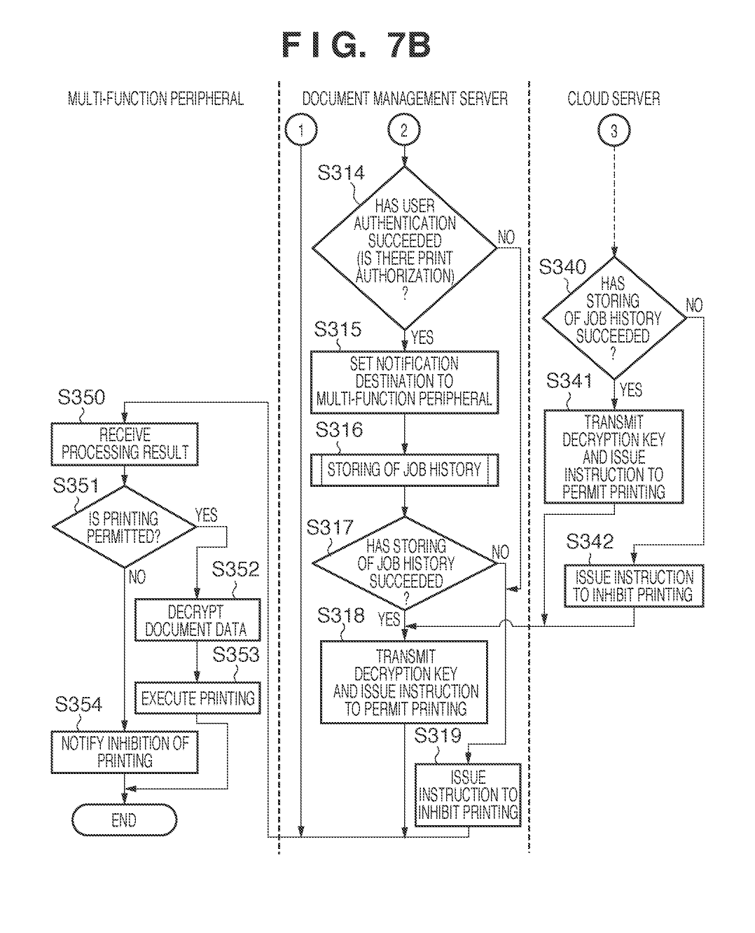

FIGS. 7A and 7B are flowcharts for printing document data taken out from the intranet of the local organization. This flowchart is based on the assumption that a similar system (the document management server 2, image processing server 3, data server 4, retrieval server 5, and authentication server 6) is built in another organization. In addition, the multi-function peripheral in FIGS. 7A and 7B is a multi-function peripheral to print carry-in document data or internally managed document data.

In step S300, the main control unit 1000 of the device recognizes, via the external memory control unit 221, a portable medium such as a USB connected by the user. In step S301, the main control unit 1000 of the device acquires document data, the path information of the document data, and global ID information (that is, the first data) from the portable medium. In step S302, the main control unit 1000 acquires user information. Assume that in this case, the main control unit 1000 acquires user information by logging in via the operation unit I/F 204 and the operation unit 234. It is possible to acquire user information by using an IC card or connecting to the portable medium in steps S300 and S301 or logging in before the acquisition of information.

In step S303, the main control unit 1000 of the digital multi-function peripheral 1 instructs the job history information control unit 1004 to generate job history information including job attribute information or the like. The job history information control unit 1004 generates job history information based on user information, the contents of the print instruction, and the like. In step S304, the main control unit 1000 of the digital multi-function peripheral 1 transmits the path information of the document data, global ID information, and job attribute information acquired in step S301, the user information acquired in step S302, and the job history information generated in step S303 to the document management server 2. A document management server as a transmission destination is the document management server 2 in the network in which the digital multi-function peripheral 1 exists. For the sake of convenience, data handled in step S304 will also be referred to as the second data.

In step S310, the main control unit 2000 of the document management server 2 receives the path information of the document data, global ID information, job history information, and user information (that is, the second data) from the digital multi-function peripheral 1. This implements the second data reception unit. In step S311, the main control unit 2000 of the document management server 2 checks whether the global ID information received in step S310 coincides with the global ID information of the local organization. If this global ID information coincides with that of the local organization (YES in step S311), the process shifts to step S312. If they do not coincide with each other (NO in step S311), the main control unit 2000 transmits the path information of the document data, global ID information, and user information to the cloud server 90, and the process shifts to step S330. At this time, in communication with the cloud server 90, the main control unit 2000 uses a technique called Comet to allow the cloud server 90 to notify the document management server 2 of information. Comet is a technique of allowing a Web server to transmit an event which has occurred in the Web server to a Web client without any request from the Web client. That is, a given global ID which coincides with the global ID of the local organization indicates that the corresponding document data is that managed by the local organization, whereas a given global ID which does not coincide with the global ID of the local organization indicates that the corresponding document data is that managed by another organization (carry-in document data). Note that if the user has designated to “record” a job history in step S108 in FIG. 5 described above, the main control unit 2000 executes the processing in step S312, and the processing in step S330 and the subsequent steps regardless of the determination result obtained in step S311. This embodiment will be further described below on the assumption that the user has designated “not to record” a job history in step S108.

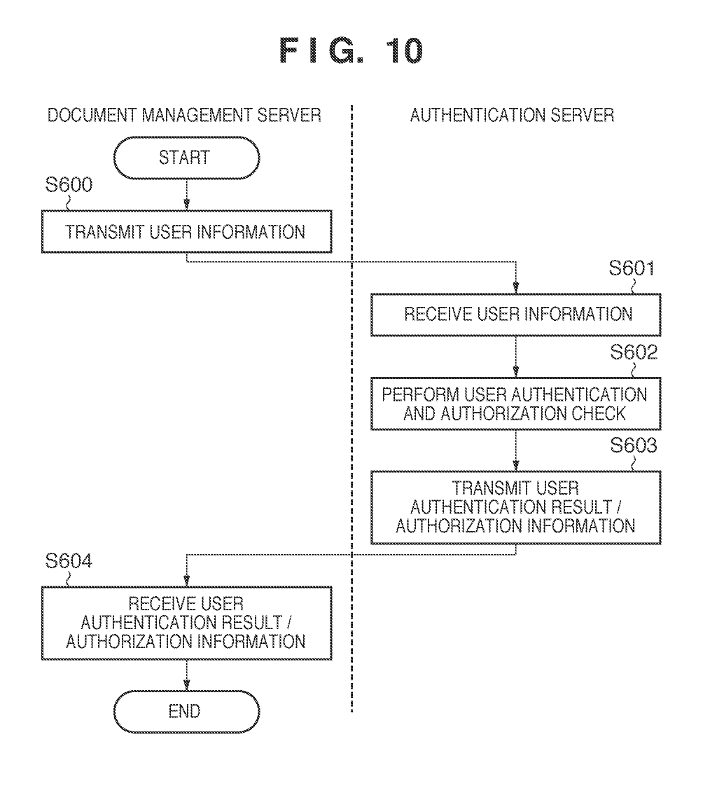

In step S312, the main control unit 2000 checks whether to record a job history concerning a print job for document data (to be referred to as carry-in document data hereinafter) carried in from outside the local organization designated by the user in step S108. Although this embodiment is described on the assumption that any job history concerning carry-in document data is not recorded, the system may prohibit the user from making this setting itself (for example, the system may not prepare any UI to designate step S108). Although not shown in FIGS. 7A and 7B, it is assumed that when document data managed by the local organization is to be printed, the processing of recording a job history concerning the document data is performed. In step S313, the main control unit 2000 of the document management server 2 performs user authentication based on the user information received in step S310. This operation will be described in detail with reference to FIG. 10. In step S314, the main control unit 2000 of the document management server 2 checks the user authentication result. If the user authentication has succeeded (YES in step S314), the process shifts to step S315. If the user authentication has failed (NO in step S314), the process shifts to step S319.

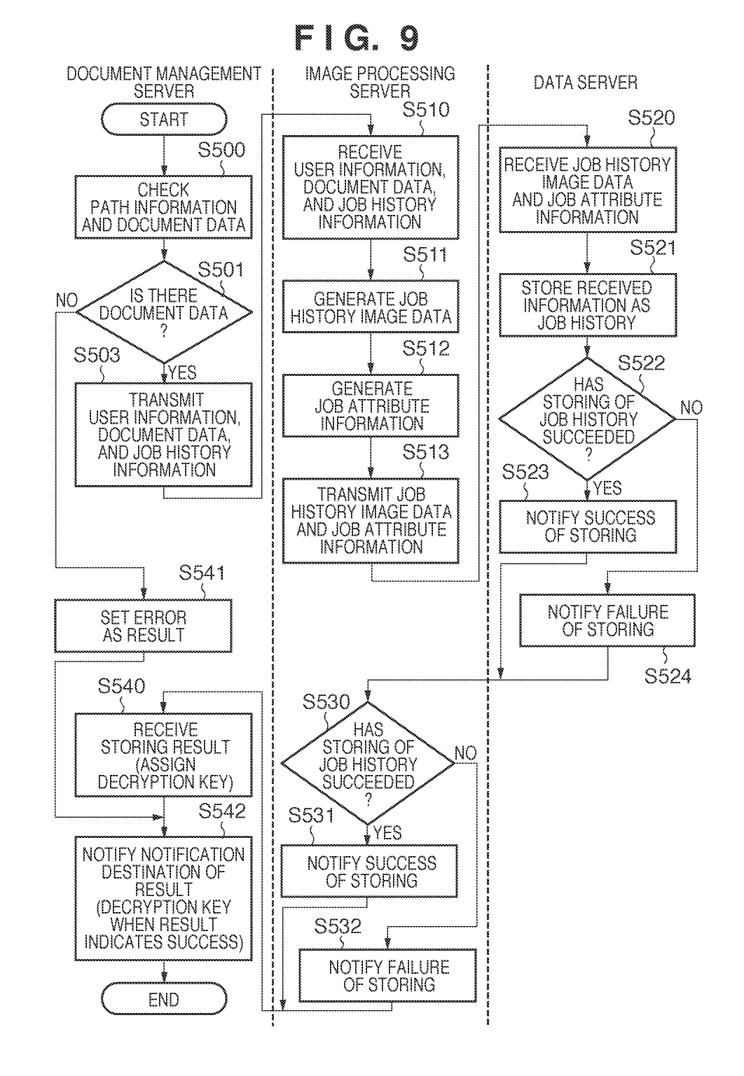

In step S315, the main control unit 2000 of the document management server 2 sets a notification destination for a job history information storing processing result to the digital multi-function peripheral 1 via the setting control unit 2003. Assume that the digital multi-function peripheral 1 at this time is the digital multi-function peripheral 1 on the same network as that of the document management server 2. In step S316, the document management server 2 connects to the image processing server 3 on the same network and executes job history information storing processing. This processing will be described in detail below with reference to FIG. 9.

In step S317, the main control unit 2000 of the document management server 2 checks the result of the job history information storing processing executed in step S316 and the job history information storing result received from the cloud server 90. This implements an instruction reception unit. If the job history information storing processing has succeeded (YES in step S317), the process shifts to step S318. If the processing has failed (NO in step S317), the process shifts to step S319. In step S318, the main control unit 2000 of the document management server 2 transmits the decryption key obtained in processing of step S316 and information associated with the permission/inhibition of printing (a permission instruction in this case) to the digital multi-function peripheral 1. This implements an instruction transmission unit. In step S319, the main control unit 2000 of the document management server 2 transmits the permission/inhibition of printing (an inhibition instruction in this case) to the digital multi-function peripheral 1.

In step S330, the main control unit 9000 of the cloud server 90 receives the path information of the document data, global ID information, job history information, and user information (that is, the second data) from the document management server 2. This implements the second data reception unit. In step S331, the main control unit 9000 of the cloud server 90 checks the global ID received in step S330. The main control unit 9000 then specifies a storage area corresponding to the global ID. In step S332, the main control unit 9000 of the cloud server 90 stores the information received in step S330 in the storage area specified in step S331. The information received in step S330 specifically indicates the path information of the document data, global ID information, job history information, and user information (that is, the second data).

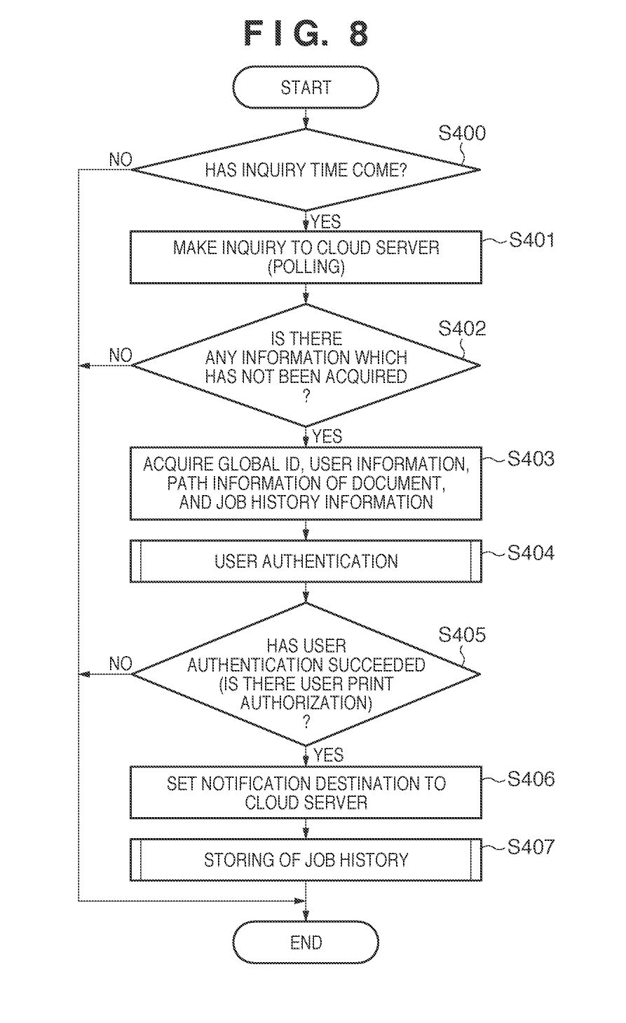

After step S332, the processing shown in FIGS. 8 and 9 which will be described later is implemented in the system. Thereafter, the processing in step S340 and the subsequent steps is executed. These processes are indicated by a broken-line arrow in FIGS. 7A and 7B, and a description of them will be omitted. FIG. 8 shows the processing of making the document management server 2 acquire information from the cloud server 90. FIG. 9 is a flowchart for job history storing processing. Note that the entity which performs job history storing processing in step S316 differs from the entity of job history storing processing omitted after step S332.

In step S340, the main control unit 9000 of the cloud server 90 performs polling in loop processing to check whether the job history storing processing has succeeded, and checks the job history information storing processing result from the document management server 2. This implements a result reception unit. Assume that this result is obtained when the document management server 2 stores the result information and decryption key in the folder for the corresponding job. If the job history information storing processing has succeeded (YES in step S340), the process shifts to step S341. If the processing has failed (NO in step S340), the process shifts to step S342. In step S341, the main control unit 9000 of the cloud server 90 transmits the decryption key obtained in the job history storing processing (which is indicated by the broken-line arrow and its description is omitted) and information associated with the permission/inhibition of printing (a permission instruction in this case) to the document management server 2. That is, the decryption key to be transmitted in this case is the decryption key received from the document management server of the system which is managing document data to be printed. The main control unit 9000 then transmits the received decryption key to the system (document management server) which is to print carry-in document data. In step S342, the main control unit 9000 of the cloud server 90 transmits information associated with the permission/inhibition of printing (an inhibition instruction in this case) to the document management server 2. Steps S341 and S342 implement an instruction transmission unit. Thereafter, the process shifts to step S317.

In step S350, the main control unit 1000 of the digital multi-function peripheral 1 receives information associated with the permission/inhibition of printing from the document management server 2, together with a decryption key if printing is permitted. In step S351, the main control unit 1000 checks the received information associated with the permission/inhibition of printing. If the information indicates a permission to print, the main control unit 1000 decrypts the document data by using the received decryption key in step S352. The main control unit 1000 then executes printing in step S353. In step S354, the main control unit 1000 of the digital multi-function peripheral 1 notifies the user of information indicating the inhibition of printing via the UI control unit 1001. With the above procedure, print processing is executed.

Note that it is possible to determine in step S340 whether job history storing processing has succeeded, based on the result of processing in step S332 which corresponds to store processing in a cloud server. In this case, job history information itself is held in the system, and hence is extracted after printing. In this case, it is necessary to register a decryption key in the cloud server in advance.

[Information Acquisition Processing]

FIG. 8 is a flowchart showing the processing of making the document management server 2 (that is, the document management server which manages take-out document data and its job history information) acquire information from the cloud server 90. This embodiment is based on the assumption that the document management server 2 performs polling processing for the cloud server 90 based on the settings designated by the user in step S107. In response to this polling processing, the cloud server 90 transmits the second data to the document management server 2. This implements the second data transmission unit. Note that it is possible to use a unit to notify the document management server 2 of information from the cloud server 90 on the Internet as a unit other than the unit for polling used in this embodiment.

In step S400, the main control unit 2000 of the document management server 2 checks whether the inquiry time setting designated in step S107 in FIG. 5 coincides with the current time. The main control unit 2000 acquires the inquiry time setting via the setting control unit 2003. The main control unit 2000 may be configured to receive a notification by using an event or the like. If the inquiry time has come (YES in step S400), the process shifts to step S401. If the inquiry time has not come (NO in step S400), this processing is terminated.

In step S401, the job history information control unit 2001 of the document management server 2 makes an inquiry to the cloud server 90 in accordance with an instruction from the main control unit 2000. In step S402, the job history information control unit 2001 of the document management server 2 checks whether the cloud server 90 contains any information which the job history information control unit 2001 manages and has not been acquired. If YES in step S402, the process shifts to step S403. If NO in step S402, job history information control unit 2001 terminates this processing. In step S403, the job history information control unit 2001 acquires the path information of document data, global ID information, job attribute information, and user information via the main control unit 9000 of the cloud server 90.

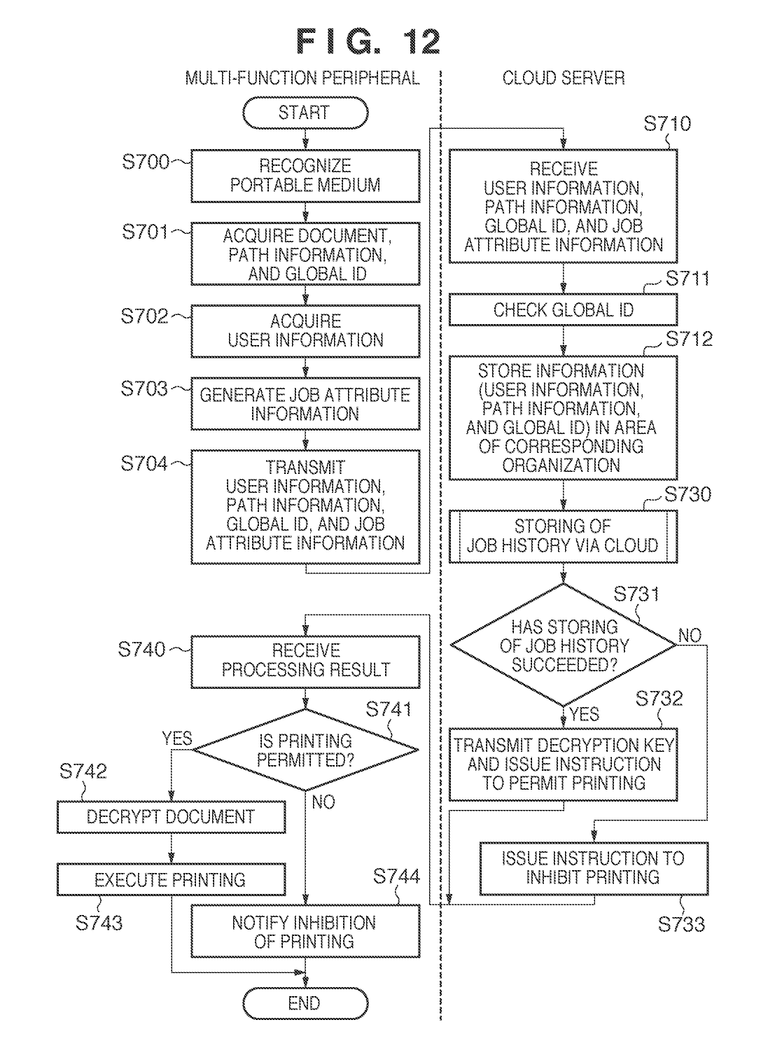

In step S404, the main control unit 2000 of the document management server 2 performs user authentication based on the user information received in step S403. User authentication will be described in detail with reference to FIG. 12. In step S405, the main control unit 2000 of the document management server 2 checks the user authentication result. If the user authentication has succeeded (YES in step S405), the process shifts to step S406. If the user authentication has failed (NO in step S405), the main control unit 2000 terminates this processing. In step S406, the main control unit 2000 of the document management server 2 sets a notification destination for the result of job history information storing processing in the cloud server 90 via the setting control unit 2003. In step S407, the document management server 2 is connected to the image processing server 3 on the same network and executes job history information storing processing. Job history information storing processing will be described later with reference to FIG. 9. This implements the second data storage unit. After step S407, the document management server 2 terminates this processing.

[Job History Information Storing Processing]

FIG. 9 is a flowchart showing the processing of making the document management server 2 store the job history information acquired from the digital multi-function peripheral 1 or the cloud server 90 in the data server 4 via the image processing server 3.

In step S500, the main control unit 2000 of the document management server 2 checks the document data acquired from the digital multi-function peripheral 1 or the cloud server 90, via the file operation unit 2004, from information concerning the document data. In this case, the information concerning the document data corresponds to the path information of the document data, global ID information, job attribute information, and user information. If the main control unit 2000 determines, from the check in step S500, in step S501 that the document data exists (YES in step S501), the process shifts to step S503. If the main control unit 2000 determines that the document data does not exist (NO in step S501), because, for example, the document data has been deleted from the document management server 2, the process shifts to step S541 to set an error as the result. After step S541, the process shifts to step S542. In step S503, the main control unit 2000 of the document management server 2 transmits the user information and job attribute information acquired from the digital multi-function peripheral 1 or the cloud server 90 and the document data checked in step S500 to the image processing server 3.

In step S510, the main control unit 3000 of the image processing server 3 receives the user information, the job attribute information, and the document data from the document management server 2. In step S511, the image processing unit 3001 of the image processing server 3 generates job history image data from the document data in accordance with an instruction from the main control unit 3000. In step S512, the main control unit 3000 of the image processing server 3 generates job attribute information to be stored as job history information. Although it is possible to use the job history information received in step S510 as job attribute information without any change, it is also possible to generate one piece of job attribute information (job history attribute information) by combining job attribute information with the property information of image data or the like in this embodiment. In step S513, the image processing unit 3001 of the image processing server 3 transmits the image data and the job attribute information respectively generated in steps S511 and S512 to the data server 4 via the main control unit 3000.

In step S520, the job history information control unit 4000 of the data server 4 receives the image data and the job attribute information from the main control unit 3000 of the image processing server 3. In step S521, the job history information control unit 4000 of the data server 4 stores the job history information in the HDD 109 via the file operation unit 4003. Upon checking the job history information storing result and determining that the storing processing has succeeded in step S522 (YES in step S522), the job history information control unit 4000 notifies the image processing server 3 of the success in step S523. If the storing processing has failed (NO in step S522), in step S524, the job history information control unit 4000 notifies the image processing server 3 of the failure.

In step S530, the main control unit 3000 of the image processing server 3 checks the storing processing result received from the data server 4. If the storing processing has succeeded (YES in step S530), the main control unit 3000 of the image processing server 3 notifies the document management server 2 of the storing processing success in step S531. If the storing processing has failed (NO in step S530), the main control unit 3000 of the image processing server 3 notifies the document management server 2 of the storing processing failure in step S532.

In step S540, the main control unit 3000 of the image processing server 3 receives the storing result. If the result from the image processing server 3 indicates a success, the main control unit 3000 acquires a decryption key from the encryption processing unit 2005. In step S542, the main control unit 3000 of the image processing server 3 notifies the notification destination set in step S315 or S406 of the result. In this case, if the job history information storing result indicates a success, the main control unit 3000 transmits a decryption key together with the result. With the above operation, the main control unit 3000 terminates this processing.

Note that as indicated by step S316 in FIG. 7B, when recording a job history concerning processing for carry-in document data, it is not necessary to transmit a decryption key, and hence the processing in steps S540, S541, and S542 is performed to notify only the result or omitted.

[Authentication Processing]

FIG. 10 is a flowchart showing the processing of making the authentication server 6 perform user authentication from the user information received from the document management server 2. In step S600, the main control unit 2000 of the document management server 2 transmits the user information received from the digital multi-function peripheral 1 or the cloud server 90 to the authentication server 6. In step S601, the main control unit 6000 of the authentication server 6 receives the user information from the document management server 2. In step S602, the main control unit 6000 of the authentication server 6 checks, via the authorization determination unit 6002, the presence/absence of a received user account and the authorization of the account. In step S603, the main control unit 6000 of the authentication server 6 transmits the user authentication result and the authorization information to the document management server 2. In step S604, the main control unit 2000 of the document management server 2 receives the user authentication result and the authorization information from the authentication server 6. With the above operation, this processing is terminated.

Note that in this embodiment, the cloud server is located on the Internet. However, the present invention is not limited to this, and can be applied to any case in which a cloud server is located on a network (external network) serving as a relay network for connection to the internal network on which each document management server is located.

Performing processing according to the above procedure makes it possible to inhibit document data taken out from an intranet from being printed unless a job history can be recorded in a predetermined job history information audit system. This can deter information leak in the system independently of user operation.

### Second Embodiment

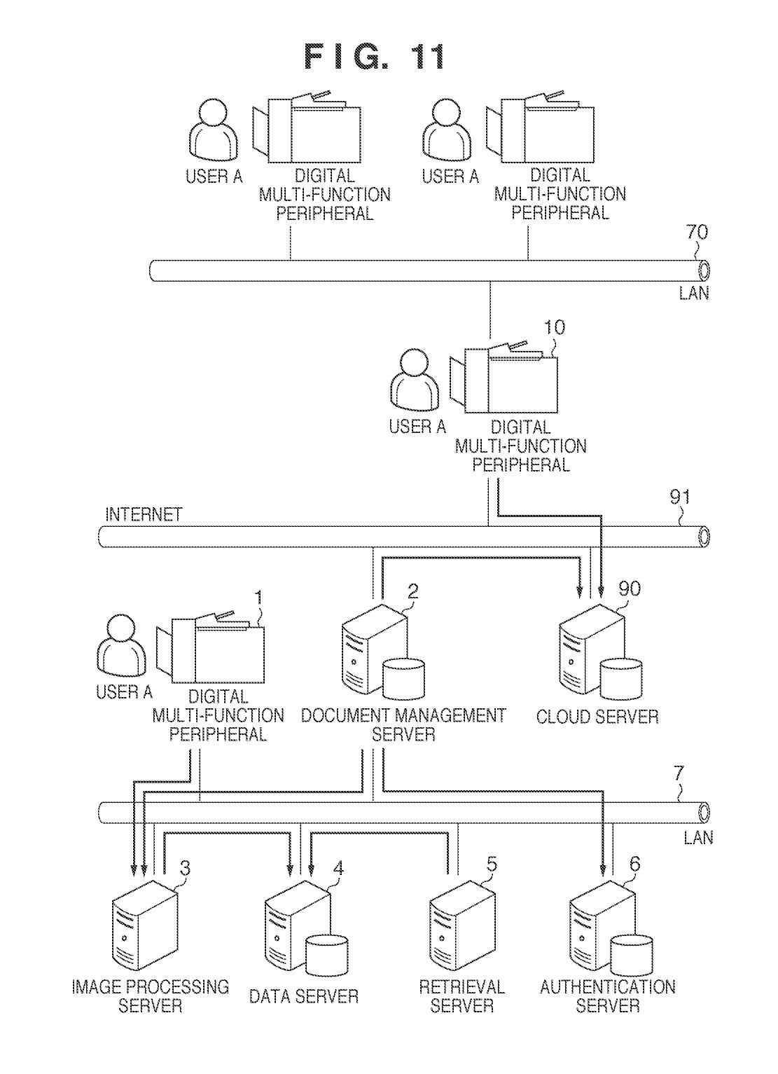

The second embodiment for executing the present invention will be described below with reference to the accompanying drawings. Only the differences between the first and second embodiments will be described below. The main difference from the first embodiment resides in the system arrangement. FIG. 11 shows an example of the arrangement.

[System Arrangement]

FIG. 11 shows the arrangement of the second embodiment. The first embodiment has the arrangement in which the document management server 20 and the image processing server 30 are connected to the LAN 70, in addition to the digital multi-function peripheral 10. The second embodiment has an arrangement in which only digital multi-function peripherals each having an arrangement similar to that of a digital multi-function peripheral 10 are connected to a LAN 70, in addition to the digital multi-function peripheral 10. Only the digital multi-function peripheral 10 (one peripheral) may be connected to the LAN 70. In the second embodiment, the digital multi-function peripheral 10 is directly connected to a cloud server 90 via the Internet 91. Since each constituent element of the second embodiment is the same as that of the first embodiment, a description of them will be omitted.

In the second embodiment, the digital multi-function peripheral 10 executes the operation condition setting in FIG. 5. That is, the only difference is that different constituent elements perform the above processing. Therefore, only the constituent elements replacing the above constituent elements will be explicitly named, and a detailed description of them will be omitted. A UI control unit 1001 of the digital multi-function peripheral 10 replaces the UI control unit 2002 of the document management server 2. A main control unit 1000 of the digital multi-function peripheral 10 replaces the main control unit 2000 of the document management server 2. A file operation unit 1003 of the digital multi-function peripheral 10 replaces the file operation unit 2004 of the document management server 2. An HDD 203 of the digital multi-function peripheral 10 replaces the HDD 109 of the document management server 2.

[Procedure for Print Processing]

A digital multi-function peripheral performs the processing performed by the document management server 2 like the processing based on the flowcharts of FIGS. 7A and 7B for printing of document data taken out from the intranet of the local organization. Any type of server (for example, a document management server or an image processing server) to store job history information concerning document data taken out from the intranet of the local organization is not connected to the digital multi-function peripheral 10 connected to the LAN of an external organization. A procedure for printing document data in this case will be described with reference to FIG. 12.

FIG. 12 is a flowchart for printing document data taken out from a local organization intranet in the second embodiment. As described above, since there is no server to store job history information on the intranet, the digital multi-function peripheral 10 always transmits job history information to the cloud server 90. Since steps S700 to S703 are the same as steps S300 to S303 in FIG. 7A, a description of them will be omitted.

In step S704, the digital multi-function peripheral 10 transmits the path information of the document data and global ID information acquired in step S701, the user information acquired in step S702, and the job history information generated in step S703 (that is, the second data) to the cloud server 90. In step S710, the main control unit 9000 of the cloud server 90 receives the path information of the document data, the global ID information, the job history information, and the user information (that is, the second data) from the main control unit 1000 of the digital multi-function peripheral 10. Since steps S711 to S732 are the same as steps S331 to S342 in FIGS. 7A and 7B, a description of them will be omitted.

In step S740, the main control unit 1000 of the digital multi-function peripheral 10 receives information concerning the permission/inhibition of printing from the cloud server 90, together with a decryption key if printing is permitted. A decryption key is generated by the document management server 2 operated in the intranet of the local organization. That is, the decryption key is generated by the document management server 2 in the organization to which the user who is to print take-out document data belongs and is transmitted from the intranet environment in which job history information should be left. Steps S741 to S744 are the same as steps S351 to S354 shown in FIG. 7B, and hence a description of them will be omitted. With the above operation, the digital multi-function peripheral terminates this processing.

The second embodiment differs from the flowchart shown in FIG. 8, which shows the processing of acquiring information from the cloud server 90, only in that the digital multi-function peripheral 10 performs the processing in place of the document management server 2. The contents of the processing are the same as those shown in FIGS. 7A and 7B. As in the case of FIGS. 7A and 7B, in the second embodiment, only constituent elements replacing the above constituent elements will be explicitly named, and a detailed description of them will be omitted. A main control unit 1000 of the digital multi-function peripheral 10 replaces the main control unit 2000 of the document management server 2. A setting control unit 1005 of the digital multi-function peripheral 10 replaces the setting control unit 2003 of the document management server 2. A job history information control unit 1004 of the digital multi-function peripheral 10 replaces the job history information control unit 2001 of the document management server 2.

With the above operation, even in a network arrangement in which a multi-function peripheral in an intranet directly connects to a cloud server via the Internet, it is possible to record a job history in a predetermined job history information audit system concerning document data taken out from the intranet. It is also possible to inhibit printing unless a job history can be recorded. This can deter information leak in the system independently of user operation.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-116698, filed May 20, 2010, which is hereby incorporated by reference herein in its entirety.

What is claimed is:

1. A job history information audit system formed by connecting, to a cooperation server located in an external network, a first document management server and a printing apparatus which are located in an internal network, and a second document management server belonging to a network different from the internal network to which said first document management server belongs, wherein
said printing apparatus comprises
an acquisition unit configured to recognize a connected portable medium and acquires first data stored in the portable medium,
a generation unit configured to generate second data including job history information concerning a history of a job processed by said printing apparatus and the first data,
a transmission unit configured to transmit the second data to said first document management server,
a reception unit configured to receive an instruction associated with permission/inhibition of printing of the second data from said first document management server, and
a printing unit configured to execute print processing when an instruction received by said reception unit permits printing of the second data,
said first document management server comprises
an acquisition unit configured to acquire identification information for identifying a document management server from said cooperation server,
a second data reception unit configured to receive the second data from said printing apparatus,
a determination unit configured to determine, based on the second data and the identification information, whether document data of the second data is document data managed by said first document management server,
a storage unit configured to store the second data when said determination unit determines that the document data is document data managed by said first document management server,
a transmission unit configured to transmit the second data to said cooperation server when said determination unit determines that the document data is carry-in document data which is not managed by said first document management server,
an instruction reception unit configured to receive the instruction associated with permission/inhibition of printing based on a result of storing processing for the second data transmitted from said cooperation server by said transmission unit, and
an instruction transmission unit configured to transmit the instruction associated with permission/inhibition of printing to said printing apparatus,
said second document management server comprises
an acquisition unit configured to acquire second data corresponding to document data managed by said second document management server from said cooperation server,
a second data storage unit configured to perform storing processing of second data corresponding to document data acquired by said acquisition unit and managed by said second document management server, and
a transmission unit configured to transmit a result of processing by said second data storage unit to said cooperation server, and
said cooperation server comprises
an assignment unit configured to assign a storage area for the identification information and data corresponding to the identification information to each document management server,
a reception unit configured to receive the second data from said first document management server,
a storage unit configured to store the received second data in the storage area of the data corresponding to the identification information based on the identification information of the second data received by said reception unit,
a second data transmission unit configured to transmit, to said second document management server, second data corresponding to document data managed by said second document management server,
a result reception unit configured to receive a result of storing processing for the second data from said second document management server, and
a transmission unit configured to transmit, to said first document management server, the instruction associated with permission/inhibition of printing based on the result of the storing processing received from said second document management server.

2. The system according to claim 1, wherein said second document management server further comprises an encryption unit configured to hold an encryption key and decryption key corresponding to document data and encrypts the document data using the encryption key when storing the document data in the portable medium, and a portable medium storage unit configured to store the encrypted document data in the portable medium,
said transmission unit transmits a decryption key corresponding to the document data to said cooperation server, together with a result of the storing processing, when the storing processing performed by said second data storage unit has succeeded,
said cooperation server causes said transmission unit to transmit the decryption key to said first document management server when said result reception unit receives the decryption key from said second document management server, together with the result of the storing processing,
said first document management server causes said instruction transmission unit to transmit the decryption key to said printing apparatus, together with the instruction associated with permission/inhibition of printing, when said instruction reception unit receives the decryption key from said cooperation server, together with the instruction associated with permission/inhibition of printing, and
said printing apparatus causes said printing unit to decrypt the document data by the decryption key and execute print processing when said reception unit receives the decryption key together with the instruction associated with permission/inhibition of printing of the document data.

3. The system according to claim 1, wherein said first document management server further comprises a condition reception unit configured to receive a condition setting for operation of the system from a user, and
said condition reception unit receives a condition setting concerning whether to store the job history information with respect to carry-in document data which is not managed by said first document management server.

4. The system according to claim 1, wherein the first data includes, as information concerning a job, at least document data, a document path, and identification information of said document management server which manages the document data.

5. An information processing apparatus functioning as a first document management server of a job history information audit system formed by connecting, to a cooperation server located in an external network, the first document management server and a printing apparatus which are located in an internal network, and a second document management server belonging to a network different from the internal network to which said first document management server belongs, comprising:
an acquisition unit configured to acquire identification information for identifying a document management server from said cooperation server;
a data reception unit configured to receive data including information concerning a job processed by said printing apparatus from said printing apparatus,
a determination unit configured to determine; based on the received data and the identification information, whether document data of the received data is document data managed by said first document management server;
a storage unit configured to store the received data when said determination unit determines that the document data is document data managed by said first document management server;
a transmission unit configured to transmit the received data to said cooperation server when said determination unit determines that the document data is carry-in document data which is not managed by said first document management server;
an instruction reception unit configured to receive the instruction associated with permission/inhibition of printing based on a result of storing processing for the data transmitted from said cooperation server by said transmission unit; and
an instruction transmission unit configured to transmit the instruction associated with permission/inhibition of printing to said printing apparatus.

6. An information processing apparatus functioning as a second document management server of a job history information audit system formed by connecting, to a cooperation server located in an external network, a first document management server and a printing apparatus which are located in an internal network, and the second document management server belonging to a network different from the internal network to which said first document management server belongs, comprising:
an acquisition unit configured to acquire data corresponding to document data managed by said second document management server from said cooperation server;
a data storage unit configured to perform storing processing of data corresponding to document data acquired by said acquisition unit and managed by said second document management server; and
a transmission unit configured to transmit a result of processing by said data storage unit to said cooperation server.

7. An information processing apparatus functioning as a cooperation server of a job history information audit system formed by connecting, to the cooperation server located in an external network, a first document management server and a printing apparatus which are located in an internal network, and a second document management server belonging to a network different from the internal network to which said first document management server belongs, comprising:
an assignment unit configured to assign a storage area for the identification information and data corresponding to the identification information to each document management server;
a reception unit configured to receive data including information concerning a job processed by said printing apparatus from said first document management server;
a storage unit configured to store the received data in the storage area of the data corresponding to the identification information based on the identification information of the data received by said reception unit;
a data transmission unit configured to transmit, to said second document management server, data corresponding to document data managed by said second document management server;
a result reception unit configured to receive a result of storing processing for the data transmitted by said data transmission unit from said second document management server; and
a transmission unit configured to transmit, to said first document management server, the instruction associated with permission/inhibition of printing based on the result of the storing processing received from said second document management server.

8. A printing apparatus of a job history information audit system formed by connecting, to a cooperation server located in an external network, a first document management server and the printing apparatus which are located in an internal network, and a second document management server belonging to a network different from the internal network to which said first document management server belongs, comprising:
an acquisition unit configured to recognize a connected portable medium and acquires first data stored in the portable medium;
a generation unit configured to generate second data including job history information concerning a history of a job processed by said printing apparatus and the first data;
a transmission unit configured to transmit the second data to said first document management server;
a reception unit configured to receive an instruction associated with permission/inhibition of printing of the second data from said first document management server; and
a printing unit configured to execute print processing when an instruction received by said reception unit permits printing of the second data.

9. A job history information audit system formed by connecting, to a cooperation server located in an external network, a printing apparatus located in an internal network and a document management server belonging to a network different from the internal network to which said printing apparatus belongs, wherein
said printing apparatus comprises
an acquisition unit configured to recognize a connected portable medium and acquire first data stored in the portable medium,
a generation unit configured to generate second data including job history information concerning a history of a job processed by said printing apparatus and the first data,
a transmission unit configured to transmit the second data to said cooperation server,
a reception unit configured to receive an instruction associated with permission/inhibition of printing of the second data from said cooperation server, and
a printing unit configured to execute print processing when an instruction received by said reception unit permits printing of the second data,
said document management server comprises
an acquisition unit configured to acquire second data corresponding to document data managed by said document management server from said cooperation server,
a storage unit configured to perform storing processing of the second data corresponding to the document data managed by said document management server which is acquired by said acquisition unit, and
a transmission unit configured to transmit a processing result obtained by said storage unit to said cooperation server, and
said cooperation server comprises
an assignment unit configured to assign a storage area for the identification information and data corresponding to the identification information to each document management server,
a reception unit configured to receive the second data from said printing apparatus,
a storage unit configured to store the received second data in the storage area of the data corresponding to the identification information based on the identification information of the second data received by said reception unit,
a second data transmission unit configured to transmit, to said document management server, second data corresponding to document data managed by said document management server,
a result reception unit configured to receive a result of storing processing for the second data from said document management server, and
a transmission unit configured to transmit, to said printing apparatus, the instruction associated with permission/inhibition of printing based on the result of the storing processing received from said document management server.

10. A job history information audit system formed by connecting a document management server and a printing apparatus which are located in an internal network to a cooperation server located in an external network, wherein
said printing apparatus comprises
an acquisition unit configured to recognize a connected portable medium and acquire first data stored in the portable medium,
a generation unit configured to generate second data including job history information concerning a history of a job processed by said printing apparatus and the first data,
a transmission unit configured to transmit the second data to said first document management server,
a reception unit configured to receive an instruction associated with permission/inhibition of printing of the second data from said first document management server, and
a printing unit configured to execute print processing when an instruction received by said reception unit permits printing of the second data,
said document management server comprises
an acquisition unit configured to acquire identification information for identifying a document management server from said cooperation server,
a second data reception unit configured to receive the second data from said printing apparatus,
a determination unit configured to determine, based on the second data and the identification information, whether document data of the second data is document data managed by said first document management server,
a storage unit configured to store the second data when said determination unit determines that the document data is document data managed by said first document management server,
a transmission unit configured to transmit the second data to said cooperation server when said determination unit determines that the document data is carry-in document data which is not managed by said first document management server,
an instruction reception unit configured to receive the instruction associated with permission/inhibition of printing based on a result of storing processing for the second data transmitted from said cooperation server by said transmission unit, and
an instruction transmission unit configured to transmit the instruction associated with permission/inhibition of printing to said printing apparatus, and
said cooperation server comprises
an assignment unit configured to assign a storage area for the identification information and data corresponding to the identification information to each document management server,
a reception unit configured to receive the second data from said document management server,
a storage unit configured to store the received second data in the storage area of the data corresponding to the identification information based on the identification information of the second data received by said reception unit, and
a transmission unit configured to transmit, to said printing apparatus, the instruction associated with permission/inhibition of printing based on a result of the storing processing in said storage unit.

11. An audit method in a job history information audit system formed by connecting, to a cooperation server located in an external network, a first document management server and a printing apparatus which are located in an internal network, and a second document management server belonging to a network different from the internal network to which the first document management server belongs, comprising:
in the printing apparatus,
an acquisition step of causing an acquisition unit to recognize a connected portable medium and acquire first data stored in the portable medium,
a generation step of causing a generation unit to generate second data including job history information concerning a history of a job processed by the printing apparatus and the first data,
a transmission step of causing a transmission unit to transmit the second data to the first document management server,
a reception step of causing a reception unit to receive an instruction associated with permission/inhibition of printing of the second data from the first document management server, and
a printing step of causing a printing unit to execute print processing when an instruction received in the reception step permits printing of the second data,
in the first document management server,
an acquisition step of causing an acquisition unit to acquire identification information for identifying a document management server from the cooperation server,
a second data reception step of causing a second data reception unit to receive the second data from the printing apparatus,
a determination step of causing a determination unit to determine, based on the second data and the identification information, whether document data of the second data is document data managed by the first document management server,
a storage step of causing a storage unit to store the second data when it is determined in the determination step in the first document management server that the document data is document data managed by the first document management server,
a transmission step of causing a transmission unit to transmit the second data to the cooperation server when it is determined in the determination step in the first document management server that the document data is carry-in document data which is not managed by the first document management server,
an instruction reception step of causing an instruction reception unit to receive the instruction associated with permission/inhibition of printing based on a result of storing processing for the second data transmitted from the cooperation server in the transmission step in the first document management server, and
an instruction transmission step of causing an instruction transmission unit to transmit the instruction associated with permission/inhibition of printing to the printing apparatus,
in the second document management server,
an acquisition step of causing an acquisition unit to acquire second data corresponding to document data managed by the second document management server from the cooperation server;
a second data storage step of causing a second data storage unit to perform storing processing of second data corresponding to document data acquired in the acquisition step in the second document management server and managed by the second document management server, and
a transmission step of causing a transmission unit to transmit a result of processing in the step of causing the second data storage unit of the second document management server to store to the cooperation server, and
in the cooperation server,
an assignment step of causing an assignment unit to assign a storage area for the identification information and data corresponding to the identification information to each document management server,
a reception step of causing a reception unit to receive the second data from the first document management server,
a storage step of causing a storage unit to store the received second data in the storage area of the data corresponding to the identification information based on the identification information of the second data received in the reception step in the cooperation server,
a second data transmission step of causing a second data transmission unit to transmit, to the second document management server, second data corresponding to document data managed by the second document management server,
a result reception step of causing a result reception unit to receive a result of storing processing for the second data from the second document management server, and
a transmission step of causing a transmission unit to transmit, to the first document management server, the instruction associated with permission/inhibition of printing based on the result of the storing processing received from the second document management server.
